(19) United States
(12) Patent Application Publication
(10) Pub. No.: US 2022/0336949 A1
(43) Pub. Date: Oct. 20, 2022

(54) COMPACT DIRECTIONAL ANTENNA, DEVICE COMPRISING SUCH AN ANTENNA

(71) Applicant: SIGFOX, LABEGE (FR)

(72) Inventor: YANN MEHUT, LABEGE (FR)

(21) Appl. No.: 17/431,417

(22) PCT Filed: Mar. 16, 2020
(86) PCT No.: PCT/EP2020/057049

§ 371 Date: Jan. 12, 2022

(30) Foreign Application Priority Data
Mar. 19, 2019 (FR) FR1902798

(51) Int. Cl. H01Q 5/378; H01Q 1/38; H01Q 19/26; H01Q 19/32; H01Q 9/30

(52) U.S. Cl. CPC H01Q 5/378; H01Q 1/38; H01Q 19/26; H01Q 19/32; H01Q 9/30

(57) ABSTRACT

A directional antenna includes an array of unitary antenna elements. The array includes an active antenna element, called “radiator element”, which is configured to be electrically connected to a radiofrequency receiver or source, and at least one passive antenna element supplied with power by mutual induction, called “parasitic element.” The radiator element is a parasitic resonator antenna having a monopole, a ground plane and a parasitic cell that is placed in the near field of the monopole. In particular embodiments, the ground plane is used to accept tracks of an electronic circuit of a transmitter or receiver device. The antenna performs particularly well in terms of directivity and radiating efficiency, while being highly compact.

### FIELD OF THE INVENTION

The present invention belongs to the field of compact directional antennas. In particular, the invention relates to a compact directional antenna adapted for geolocating connected objects transmitting radio signals, as well as a device using such an antenna.

### BACKGROUND OF THE INVENTION

The miniaturisation of antennas has been the object of much research and development for several years. Current solutions are based on different techniques subject to different physical limitations. Also, these solutions often result from a compromise between directivity, size, radiation efficiency and bandwidth.

The size of an antenna generally depends on the wavelength for which the antenna is designed: the lower the working frequency, the greater the associated wavelength, and the greater the dimensions of an antenna adapted for this working frequency. Furthermore, R. F. Harrington demonstrated in 1959 that an antenna whose dimensions can be included in a sphere of radius R has a directivity proportional to (R²+2R). In other words, the more compact the antenna, the lower its directivity.

Thus, it is understood that it is difficult to design and integrate an antenna with high directivity in connected objects of small sizes, in particular for frequencies below one gigahertz.

An existing solution for producing a directional antenna consists in disposing several unitary antenna elements in an array. Only one of these elements, called the “radiator element”, is supplied with power. The other elements, called “parasitic elements” are supplied with power by mutual induction. The electromagnetic field radiated by the antenna in a given direction corresponds to the sum of the fields radiated by each of the elements. By correctly placing the different elements relative to each other, it is possible to focus the power radiated by the antenna in a preferred direction and therefore to increase the directivity of the antenna. Generally, the various elements of the array are of the same nature and have similar shapes and dimensions. These are, for example, electric dipoles which can be formed by rods or metal strips. The best-known example of such an antenna is the Yagi-Uda antenna (named after its inventors, Hidetsugu Yagi and Shintaro Uda).

For working frequencies below one gigahertz, however, such an antenna does not generally have satisfactory performance both in terms of directivity, radiation efficiency and compactness. In particular, for a working frequency of about 870 MHz, it seems difficult to obtain such an antenna having both a directivity greater than 8 dBi, a radiation efficiency greater than −3 dB, and a larger dimension of the antenna less than twenty centimetres.

The dimensions of a transmission or reception device using such an antenna depend not only on the dimensions of the antenna, but also on the dimensions of the electronic board which carries the various electronic components of the device. This electronic board is generally connectorised to the antenna, and it must be positioned so that it does not disturb the performance of the antenna. This generally contributes to relatively large dimensions of the transmission or reception device.

### OBJECT AND SUMMARY OF THE INVENTION

The purpose of the present invention is to overcome all or part of the disadvantages of the prior art, in particular those set out above, by proposing an antenna having good performance both in terms of directivity, of radiation efficiency and of compactness. The antenna according to the invention also has the possibility of integrating the electronic components of a reception device either directly on a ground plane of the antenna, or on a printed circuit board positioned opposite and close to the ground plane of the antenna. This allows to limit the dimensions of the receiving device, while avoiding disturbing the performance of the antenna.

As a reminder, the directivity of an antenna in one direction is the ratio between the surface power density radiated by the antenna in this direction at a given distance and the power density that would be radiated by an isotropic antenna radiating the same total power. Directivity has no unit; it is usually expressed in isotropic decibels (dBi). By abuse of language, generally “directivity of an antenna” means the value of the directivity of the antenna in the direction wherein the directivity is maximum. The radiation efficiency of an antenna is defined by the ratio between the radiated power and the power injected at the input of the antenna. This parameter reflects the losses present on the antenna. The gain of an antenna in a given direction is the product of the directivity of the antenna in that direction and the radiation efficiency of the antenna.

According to a first aspect, the present invention proposes a directional antenna including an array of unitary antenna elements. The array includes an active antenna element, called a “radiator element”, intended to be electrically connected to a radiofrequency source or receiver, and at least one passive antenna element supplied with power by mutual induction, called “parasitic element”. The radiator element is a parasitic resonator antenna including a monopole, a ground plane and a parasitic cell that is placed in the near field of the monopole.

Such an antenna differs from antennas of the prior art in that the radiator element has a different nature from parasitic elements. The radiator element indeed has a magnetic dipole behaviour while the other elements of the array behave like electric dipoles. The antenna according to the invention performs particularly well in terms of directivity and radiation efficiency while remaining highly compact. Furthermore, the presence of a ground plane, which is generally not desired in this type of antenna, can advantageously allow to integrate all or part of the electronic modules of a transmitter and/or receiver device including such an antenna.

In particular embodiments, the invention may further include one or more of the following features, taken in isolation or in any technically possible combination.

In particular embodiments, the radiator element and said at least one parasitic element of the array are formed in the same plane. The use of a planar array reduces the size of the antenna.

In particular embodiments, the array includes at least one parasitic element of reflector type and at least one parasitic element of director type. A reflector element and a director element are aligned with the radiator element, on either side of the radiator element, along an axis of the array corresponding to a direction wherein the gain of the antenna is maximum. The presence of at least one reflective element and at least one director element improves the performance of the antenna in terms of directivity.

In particular embodiments, the antenna includes three parasitic elements including one reflector element and two director elements, each parasitic element being formed by an electric dipole bent in the shape of meanders. The fact of bending the branches of the electric dipoles in the shape of meanders allows to limit the dimensions of the antenna.

In particular embodiments, the monopole is intended to be electrically connected to the radiofrequency source or receiver, and the parasitic cell of the radiator element is in the shape of an open loop.

In particular embodiments, the working frequency of the antenna is less than one gigahertz, the array of elements has a length of less than twenty centimetres and a width of less than ten centimetres, and the antenna has a maximum directivity value greater than 8 dBi and a radiation efficiency greater than −3 dB.

In particular embodiments, the ground plane of the radiator element includes electrical tracks for an electronic circuit of a transmission or reception device, said electrical tracks being etched within the ground plane. The fact of integrating the electronics of the transmission or reception device on the ground plane allows to limit the dimensions of said device.

According to a second aspect, the present invention relates to a transmitter or receiver device comprising a directional antenna according to any one of the preceding embodiments.

In particular embodiments, the transmitter or receiver device further includes an electronic circuit positioned opposite the ground plane of the radiator element of the antenna.

Such an electronic circuit corresponds to a set of electronic components of at least one electronic module of the receiving device. The various electronic components are generally interconnected using a printed circuit on a printed circuit board (PCB).

### BRIEF DESCRIPTION OF THE FIGURES

The invention will be better understood upon reading the following description, given by way of non-limiting example, and made with reference to FIGS. 1 to 8 which represent:

FIG. 1 is a schematic representation of a first face of a printed circuit board on which is produced a particular embodiment of an antenna according to the invention;

FIG. 2 is a schematic representation of the other side of the printed circuit board shown in FIG. 1;

FIG. 3 is a particular embodiment of the parasitic cell of the radiator element of the antenna according to the invention;

FIG. 4 is another particular embodiment of the parasitic cell;

FIG. 5 is another particular embodiment of the parasitic cell;

FIG. 6 is another particular embodiment of the parasitic cell;

FIG. 7 is a radiation pattern of the antenna according to the invention for a particular embodiment;

FIG. 8 is a radiation pattern of the antenna according to the invention for another particular embodiment; and

FIG. 9 is a detailed representation of the ground plane of the radiator element of the antenna according to a particular embodiment.

In these figures, identical references from one figure to another designate identical or similar elements. For reasons of clarity, the elements represented are not necessarily on the same scale, unless otherwise indicated.

### DETAILED DESCRIPTION OF AN EMBODIMENT OF THE INVENTION

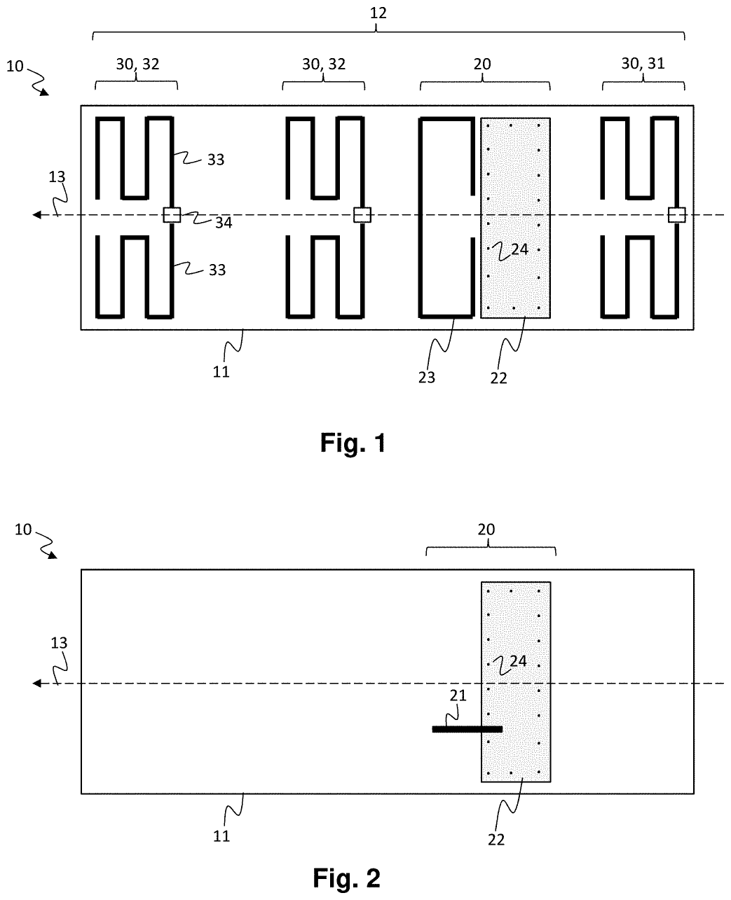

FIG. 1 schematically shows a particular embodiment of an antenna 10 according to the invention.

As illustrated in FIG. 1, in the example considered the antenna 10 includes an array 12 of four unitary antenna elements. The array 12 is a planar array. In other words, all the antenna elements forming the array 12 are disposed in the same plane. This allows to limit the volume occupied by the antenna 10, and consequently to limit the dimensions of the receiving device which carries the antenna 10. For example, the various antenna elements are disposed on a printed circuit board 11 (PCB).

When the antenna 10 operates in transmission, one of the elements, called “radiator element 20” is electrically supplied with power by an RF source, that is to say by an electric current oscillating at the frequency of a radio wave. The term “radio wave” means an electromagnetic wave the frequency of which varies from a few Hertz (Hz) to several hundred Gigahertz (GHz). This current is for example conveyed between the source and the antenna by a power cable (for example a coaxial cable). The RF source and the power cable are not shown in the figures. When the antenna 10 is operating in reception, the radiator element 20 is electrically connected to an RF receiver. The electric current induced by the electromagnetic field observed at the radiator element 20 can thus be converted into an electrical signal then amplified at the RF receiver. Again, the connection between the antenna 10 and the RF receiver can be made, in a conventional manner, by a coaxial cable.

The other three elements, called “parasitic elements 30” are not supplied with power. These are passive elements supplied with power by mutual induction coupling. This type of array 12 wherein a single element is electrically supplied with power allows to limit the size of the antenna 10 because there is no need to create a complex electrical power supply array for the various elements.

The radiator element 20 and the three parasitic elements 30 are aligned in a direction 13 wherein the gain of the antenna 10 is maximum. One of the parasitic elements 30 acts as a “reflector element 31”, while the other two parasitic elements 30 act as “director elements 32”.

A reflector element 31 is disposed relative to the radiator element 20 opposite to the direction 13 of maximum gain of the antenna 10. A director element 32 is disposed relative to the radiator element 20 in the direction 13 of maximum gain of the antenna 10. In other words, a reflector element 31 and a director element 32 are disposed on either side of the radiator element 20.

When the antenna 10 operates in transmission, the electric current circulating in the radiator element 20 produces by radiation an electromagnetic field which induces currents in the other elements. The current induced in the parasitic elements 30 in turn produces other electromagnetic fields which induce current in the other elements (both in the parasitic elements 30 and in the radiator element 20). Ultimately the current circulating in each element is the result of the interaction between all the elements. It depends on the positions and dimensions of each element. Thus, the electromagnetic field radiated by the antenna 10 in a given direction is the sum of the electromagnetic fields radiated by each of the elements of the array 12. Each element has a different amplitude and a different phase of the current. Constructive or destructive additions of electromagnetic fields can thus be observed according to the phase shift specific to each element. A director element 32 which is placed towards the front of the antenna 10 reinforces the electromagnetic field in the direction 13 (that is to say in the direction of radiator element 20 to director element 32). A reflector element 31 which is placed towards the back of the antenna 10 reflects the electromagnetic field to strengthen it in direction 13 (that is to say in the direction of reflector element 31 to radiator element 20). The positions and dimensions of the elements of the array 12 are calculated so that the phases of the resulting currents are such that the addition of the electromagnetic fields is minimum towards the back and maximum towards the front.

When the antenna 10 operates in reception, the phase and the amplitude of the currents induced in the elements is such that the current induced in the radiator element 20 connected to the RF receiver is minimum for the waves coming from the back and maximum for the waves coming from the front relative to the direction 13.

In the example under consideration, the parasitic elements 30 are electric dipoles formed by metal strips printed on the printed circuit board 11. As shown in FIG. 1, to limit the dimensions of the antenna, each electrical dipole is bent in a meandering shape. Each dipole has two branches 33. The two branches 33 of a dipole are symmetrical with each other relative to an axis along the direction 13 of maximum gain of the antenna 10 and passing through the middle of the printed circuit board 11 on which the antenna 10 is manufactured. For each electric dipole, the two branches 33 can be separated by a phase shift circuit 34 including resistive, capacitive and/or inductive components allowing to optimise the directivity performance of the antenna 10. The phase shift circuits 34 allow in particular to introduce at each parasitic element 30 the phase shift necessary to optimise the directivity of the antenna 10.

FIG. 1 shows one side of the printed circuit board 11 on which the various elements of the antenna 10 are disposed. FIG. 2 shows the other side of the printed circuit board 11.

As illustrated in FIGS. 1 and 2, the radiator element 20 is a parasitic resonator antenna including a monopole 21, a ground plane 22 and a parasitic cell 23 that is placed in the near field of the monopole 21.

In the example considered, the ground plane 22 includes two superimposed layers, each layer being respectively disposed on one face of the printed circuit board 11. The two layers of the ground plane 22 are thus facing each other. The two layers of the ground plane 22 are for example electrically connected to one another by a multitude of vias 24. The term “via” means a metallised hole in the printed circuit board 11 which allows to establish a connection between the two faces of said board 11. It should be noted that nothing prevents the use of a ground plane 22 which has only a single layer disposed on only one of the faces of the printed circuit board 11. The ground plane 22 is made of an electrically conductive material, for example made of metal.

In the embodiment described with reference to FIG. 1, the ground plane 22 has a rectangular shape. Obviously, the ground plane 22 can be a flat electrical conductor taking another shape, and the choice of a particular shape for the ground plane 22 only represents variants of the invention.

The monopole 21 is formed by a metal strip printed on the face of the printed circuit board 11 opposite to the face on which the electric dipoles of the parasitic elements 30 are printed. The RF source (for an antenna in transmission) and/or the RF receiver (for an antenna in reception) is (are) electrically connected, on the one hand, to the monopole 21 by a first power supply cable (positive pole), and on the other hand, to the ground plane 22 by a second power supply cable (negative pole). For example, a coaxial cable can be used for the power cable. It should be noted that the part of the monopole 21 which appears superimposed on the ground plane 22 in FIG. 2 is actually slightly raised relative to the ground plane 22, in other words the monopole 21 is not directly in contact with the ground plane 22.

An impedance matching circuit can be added, for example at the connection of the monopole 21 with the RF source or receiver.

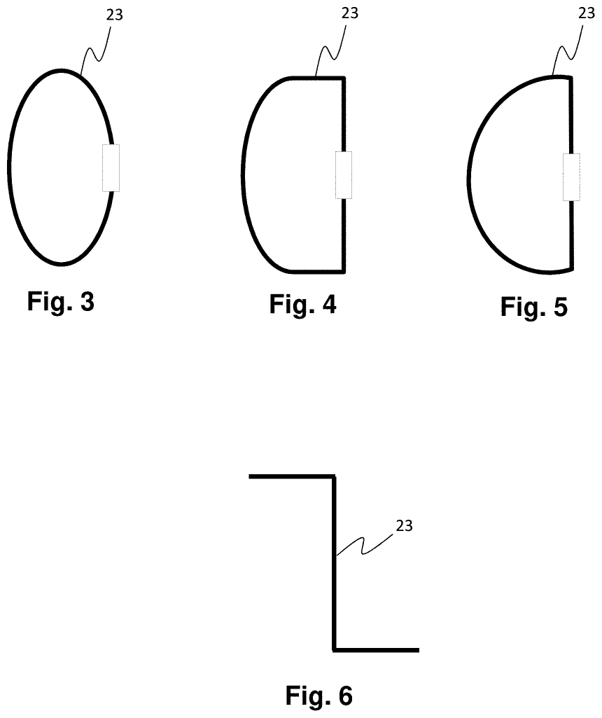

The parasitic cell 23 is formed by a printed strip in the shape of an open loop. “Open loop” means that the strip forms a loop, but that the two ends of the strip do not touch each other. In other words, an opening is made in the loop. In the example considered and illustrated in FIG. 1, the loop takes the shape of a rectangle. It should however be noted that other shapes are possible for the parasitic cell 23. In particular, and as illustrated in FIGS. 3 to 5, the loop can also take the shape of an oval ring (see FIG. 3), the shape of the letter D (see FIG. 4), or the shape of a semicircle or semi-oval with a rectilinear portion to partially close the semicircle or semi-oval (see FIG. 5). In all cases, it is advisable to leave an opening in the loop.

In particular embodiments, it is possible to reduce the size of the parasitic cell 23 by connecting the free ends of the metal strip forming the loop of said parasitic cell 23 to the electrodes of a capacitor.

In particular embodiments, and as illustrated in FIG. 6, the parasitic cell 23 takes the shape of a Z resonator rather than the shape of an open loop.

Thus, the radiator element 20 corresponds to an NFRP (acronym for “Near-Field Resonant Parasitic”) resonator using a capacitive loop (NFRP antenna of CLL type, acronym for “Capacitively Loaded Loop”). The parasitic cell 23 is placed in the near field of the monopole 21. The monopole 21 has a capacitive behaviour and is indirectly adapted by the parasitic cell 23 which in turn has an inductive behaviour. An LC-type resonant circuit is thus obtained, by an evanescent wave coupling phenomenon in the near field between the monopole 21 and the parasitic cell 23, which results in the propagation of a wave in the far field.

Such a radiator element 20 has the advantage, on the one hand, of having a unitary radiation pattern oriented in the axis of the array 12 of the antenna 10, that is to say in the direction 13 wherein it is desired to obtain the maximum gain (which contributes to the good directivity of the antenna 10 in this direction 13), and on the other hand, of including a ground plane 22 (the advantage related to the presence of the ground plane 22 will be discussed later in the description).

It should also be noted that the use of such a radiator element 20, different from the parasitic elements 30, allows to obtain very good performance not only in terms of directivity, but also in terms of radiation efficiency. Indeed, in the example considered, the antenna 10 has a directivity greater than 8 dBi and an output efficiency greater than −3 dB, which means that more than 50% of the power injected into the antenna 10 is radiated by the antenna 10. As a comparison, a similar antenna for which the radiator element 20 would be formed by an electric dipole identical to the parasitic elements 30 has a directivity which is hardly better of the order of 9 dBi, but an efficiency of radiation less than −15 dBi, which means that less than 5% of the power injected into the antenna is radiated.

In the example considered, the monopole 21 is disposed on the face of the printed circuit board 11 opposite to the face on which the parasitic cell 23 is disposed. However, nothing prevents the monopole 21 and the parasitic cell 23 from being disposed on the same face of the printed circuit board 11. Thus, in particular embodiments, all the elements of the array 12 of the antenna 10 can be disposed on the same face of a printed circuit board. When the monopole 21 and the parasitic cell 23 are each disposed on a different face of the printed circuit board 11, as shown in FIGS. 1 and 2, the coupling between these two elements is mainly of an electrical nature. When the monopole 21 and the parasitic cell 23 are disposed on the same face of a printed circuit board, the coupling between these two elements is mainly magnetic in nature. It is advantageous, in terms of size, that the monopole 21 and the parasitic cell 23 are each disposed on a different face of the printed circuit board 11, because they can then be superimposed, as shown in FIGS. 1 and 2.

In the remainder of the description, the case where the antenna 10 described above with reference to FIGS. 1 and 2 is an antenna 10 for a reception device used to geolocate connected objects transmitting radio signals is considered as an example and in a non-limiting manner.

In the example considered, the working frequency is at 869.5 MHz, and the receiving device must have sufficiently small dimensions for the receiving device to fit in the hand of a user, for example in the manner of a TV remote control. The searched connected objects repeatedly transmit radio signals at the working frequency, and the user can move around and point the receiving device in different directions in space in an attempt to detect a signal transmitted by an object. Therefore, the antenna should have a strong directivity to accurately detect the direction wherein a detected object is located, as well as good radiation efficiency to increase the distance of detection of an object by the receiving device.

In the example considered, the printed circuit board 11 on which the antenna 10 is made has a length of 165 mm and a width of 50 mm. The board 11 is made from a dielectric material of the Rogers RO4350B type. It is a ceramic substrate reinforced with woven glass fibre with a dielectric permittivity ε=3.48. The different radiating elements (monopole 21 and parasitic cell 23 of the radiator element 20, parasitic elements 30) and the two layers of the ground plane 22 are printed on the printed circuit board 11 in the shape of an 18 μm thick copper layer. For each parasitic element 30, each branch of the electric dipole has a total length of 96 mm and a width of 2 mm. For the radiator element 20, the monopole 21 has a length of 11 mm and a width of 1 mm. Each layer of the ground plane 22 is a 48 mm long and 18 mm wide rectangle. The loop of the parasitic cell 23 is formed by a 2 mm wide strip forming a 47 mm long and 18 mm wide rectangle.

In order to maximise the directivity of the antenna 10, the inter-element distance has been carefully studied so as to obtain the best possible compromise between size and coupling. This distance is particularly small relative to the inter-element distance generally observed in a conventional array (where it is typically of the order of half a wavelength at the working frequency). This small distance is necessary to obtain the “super-directive” behaviour. Indeed, the closer the elements of the array 12 are to each other, the more the theoretical directivity of the antenna 10 tends to around N², where N is the number of elements in the array 12. However, it is necessary to note that the smaller the inter-element distance, the more the coupling between the elements is increased, which has a negative effect on the efficiency of the array 12. An acceptable compromise must therefore be reached between directivity and efficiency.

Once the geometry of the antenna 10 was frozen, it was simulated, in a conventional manner, with an electromagnetic simulation software to obtain the unit radiation patterns and the S parameters of the array 12 (from “Scattering parameters”, these are the distribution coefficients to describe the electrical behaviour of an antenna element as a function of input signals). The radiation patterns and the S parameters were then processed by an algorithm to determine the complex weight to be applied to each parasitic element 30 to optimise the directivity of the antenna 10 in a given direction. An approach of the “curve fitting” type was used, wherein it is sought to minimise the difference, in the sense of least squares, between an ideal template and the pattern actually obtained by applying the complex weights. The antenna 10 radiation pattern obtained is a linear combination of the different unit patterns. This is the sum of the unit patterns of the various antenna elements of the array 12 weighted respectively by their complex weight.

Then, it remains to convert the complex weights into resistances and/or reactances which will be inserted between the branches of the electric dipoles corresponding to the parasitic elements 30 (this involves determining the electronic components which must form the phase shift circuits 34). This is done by studying the S parameters of each parasitic element 30. The complex weight of a parasitic element 30 is normalised relative to the complex weight of the radiator element 20, then the reflection coefficient which will meet the requirements in terms of directivity is determined for each parasitic element 30. This results in matrix calculations which can be carried out, in a manner known to the person skilled in the art, with a software of the Matlab type.

These simulation calculations allow to define the components of the phase shift circuits 34 of the parasitic elements 30 of the antenna 10.

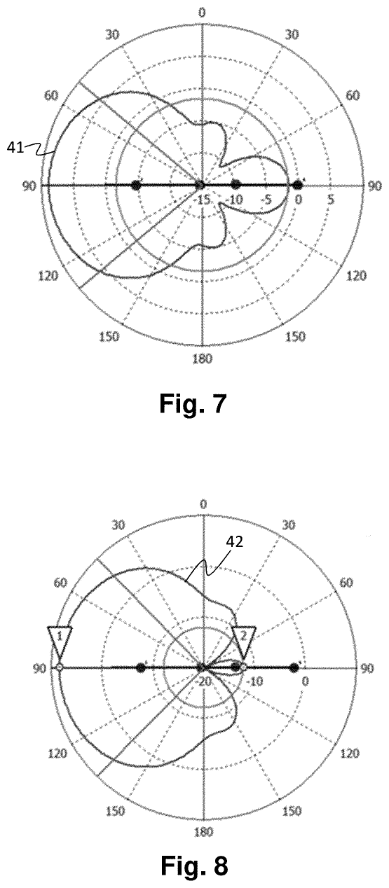

FIG. 7 schematically shows a radiation pattern at 869.5 MHz of the antenna 10 previously described with reference to FIGS. 1 and 2 when the phase shift circuit 34 of the director element 32 furthest from the radiator element 20 consists in a capacitor C₂ of value 15 pF, the phase shift circuit 34 of the director element 32 closest to the radiator element 20 consists of a capacitor C₃ of value 10 pF, and the phase shift circuit 34 of the reflector element 31 consists of a capacitor C₄ of value 8.2 pF. The directivity of the antenna 10 is represented by the curve 41. The directivity in the direction 13 assumes a satisfactory value, greater than 8 dBi. However, the front/back ratio is not optimal since a relatively large secondary lobe exists in the direction opposite to the direction 13 of the main lobe. Front/back ratio means the ratio between the directivity in the direction 13 towards the front of the antenna 10 and the directivity in the opposite direction towards the back of the antenna 10.

A parametric study with the electromagnetic simulation software has shown that by taking a value of 8.2 pF for the capacitor C₃ of the phase shift circuit 34 of the director element 32 closest to the radiator element 20, it is possible to increase the front/back ratio by about ten dB without significantly degrading the directivity of the antenna 10 (the latter going from 8.75 dBi to 8.25 dBi). In the example considered, the front/back ratio is greater than 20 dB. In the application considered, it is advantageous to have a good front/back ratio to discriminate with sufficient certainty the direction of arrival of a signal transmitted by an object that is sought to be located. The corresponding radiation pattern is shown in FIG. 8. The directivity of the antenna 10 is shown by curve 42 on this pattern.

In the example considered, the capacitors C₂, C₃ and C₄ are ceramic capacitors mounted on the surface (SMD type components for “Surface Mounted Device”).

The presence of a ground plane 22 is particularly advantageous for reducing the dimensions of the receiving device insofar as the electronic components allowing to produce the various electronic modules of the device (amplification, filtering, analogue/digital conversion, power supply, etc.) can be embedded either directly on the ground plane 22, or on another printed circuit board positioned opposite the ground plane 22.

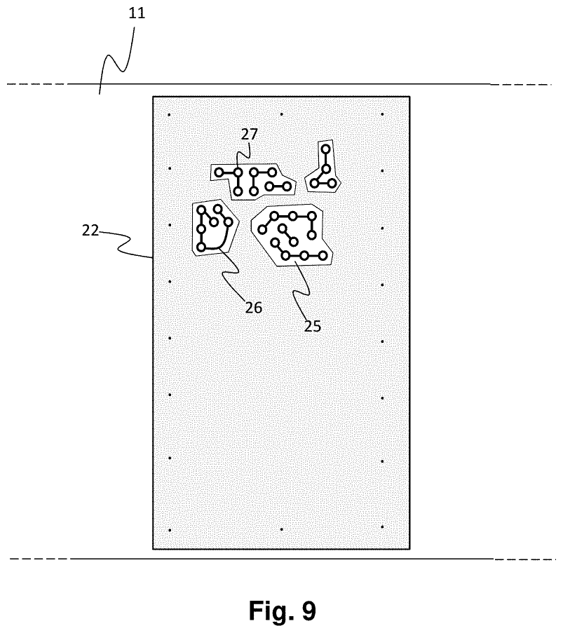

FIG. 9 schematically shows a layer of the ground plane 22 of the radiator element 20 of the antenna 10. As illustrated in FIG. 9, “holes”, that is to say areas 25 without copper are provided within the ground plane 22. In each area 25 without copper, tracks 26 and pads 27 of copper electrical circuits are printed by screen printing, in a conventional manner, on the printed circuit board 11 on which the antenna 10 is made. The tracks 26 form a copper path making the electrical interconnection between the electronic components which will be soldered at the pads 27.

Preferably, the largest dimension of an area 25 without copper is negligible compared to the wavelength of the working frequency of the antenna 10, for example the largest dimension of an area 25 without copper does not exceed a tenth of the wavelength of the working frequency of the antenna 10. Such arrangements allow to guarantee that the ground plane 22 correctly plays its role within the radiator element 20 even if a part of the ground plane 22 is used to accept electronic components of the receiving device.

In the example considered, the ground plane 22 includes two copper layers (one layer on each side of the printed circuit board 11 on which the antenna 10 is made) connected by vias. Only one layer of the ground plane 22 is shown in FIG. 9. Electronic components can be disposed on one of the two layers, or else on the two layers of the ground plane 22. Nothing prevents, as indicated previously, that the ground plane 22 includes only one layer.

Alternatively, or in addition, electronic components of the receiving device can be disposed on another printed circuit board than the printed circuit board 11 on which the antenna 10 is made. In such a case, the printed circuit board on which are disposed electronic components of the receiving device can advantageously be positioned facing the ground plane 22, at a small distance from the ground plane 22, for example only at a few millimetres. With such arrangements, the ground plane 22 advantageously allows to shield any electromagnetic disturbances generated by the electronic components of the receiving device. Such electromagnetic disturbances would indeed be liable to disrupt the operation of the antenna 10.

The above description clearly illustrates that, by virtue of its various features and their advantages, the present invention achieves the objectives set. In particular, the antenna 10 has very good performance both in terms of directivity, radiation efficiency and compactness. The antenna according to the invention also has the possibility of integrating the electronic components of the receiving device either directly on the ground plane 22 of the antenna 10, or on a printed circuit board positioned opposite and close to the ground plane 22 of the antenna 10. This contributes to limiting the dimensions of the receiving device, while avoiding disturbing the performance of the antenna.

The invention was described by considering an antenna 10 for a reception device having the purpose of locating connected objects transmitting radio signals. However, following other examples, nothing excludes considering other applications. In particular, the antenna 10 can be perfectly adapted to a transmitter device, or to a transmitter-receiver device.

In general, it should be noted that the embodiments considered above were described by way of non-limiting examples, and that other variants can therefore be considered.

In particular, other choices can be considered for the number, shape and dimensions of parasitic elements 30 for an antenna 10 according to the invention. The same is true for the number of director elements and the number of reflective elements. In particular, nothing prevents having parasitic elements 30 of different sizes, for example director elements 32 shorter than the reflector element(s) 31.

Also, nothing prevents having an antenna 10 whose array 12 is not planar, that is to say whose elements are not formed in the same plane. The size of the antenna 10 is nevertheless advantageously reduced when the array is planar.

The parasitic resonator antenna corresponding to the radiator element 20 can be made in different ways. In particular, and as indicated above, the parasitic cell 23 can take different shapes, the ground plane 22 can have only one layer instead of two, etc. These different choices represent only variations of the invention.

Also, other choices of material can be made for the printed circuit board 11, the radiating elements of the antenna 10, the components of the phase shift circuits 34, etc., without departing from the scope of the invention.

In the example considered, the array 12 of elements of the antenna 10 has a length of less than 200 mm and a width of less than 100 mm (or even a length of less than 165 mm and a width of less than 50 mm) for a working frequency less than 1 GHz (in particular, the working frequency is 869.5 MHz). The antenna 10 has a maximum directivity value greater than 8 dBi and a radiation efficiency greater than 50%. In variants of the invention, another working frequency, and other dimensions of the antenna 10 are obviously conceivable. Different values of directivity and radiation efficiency could then be obtained.

1-8. (canceled)

9. A directional antenna comprising an array of unitary antenna elements, the array comprising a radiator element configured to be electrically connected to a radiofrequency source or receiver, and at least one parasitic element, supplied with power by a mutual induction, the radiator element being a parasitic resonator antenna comprising a monopole, a ground plane and a parasitic cell placed in a near field of the monopole, wherein the radiator element and said at least one parasitic element of the array are formed in a same plane.

10. The directional antenna of claim 9, wherein the array comprises at least one parasitic element of reflector type and at least one parasitic element of director type, each aligned with the radiator element on either side of the radiator element, along an axis of the array corresponding to a direction wherein a gain of the directional antenna is at a maximum.

11. The directional antenna of claim 10, wherein the array comprises three parasitic elements comprising one parasitic element of reflector type and two parasitic elements of directory type, each parasitic element being formed by an electric dipole bent in a shape of meanders.

12. The directional antenna of claim 9, wherein the monopole is configured to be electrically connected to the radiofrequency source or receiver and the parasitic cell of the radiator element is in a shape of an open loop.

13. The directional antenna of claim 12, wherein a working frequency of the directional antenna is less than one gigahertz, and the array has a length less than twenty centimetres and a width less than ten centimetres.

14. The directional antenna of claim 9, wherein the ground plane of the radiator element comprises electrical tracks for an electronic circuit of a transmission or reception device, the electrical tracks being etched within the ground plane.

15. A transmitter device comprising the directional antenna of claim 9.

16. The transmitter device of claim 15, further comprising an electronic circuit positioned facing the ground plane of the radiator element of the directional antenna.

17. A receiver device comprising the directional antenna of claim 9.

18. The receiver device of claim 17, further comprising an electronic circuit positioned facing the ground plane of the radiator element of the directional antenna.
